(19) United States
(12) Patent Application Publication
(10) Pub. No.: US 2017/0363797 A1
(43) Pub. Date: Dec. 21, 2017

(54) TRANSPARENT DISPLAY WITH IMPROVED CONTRAST AND TRANSMISSION

(71) Applicant: Corning Incorporated, Corning, NY (US)

(72) Inventor: Jacques Gollier, Redmond, WA (US)

(21) Appl. No.: 15/532,363

(22) PCT Filed: Dec. 2, 2015
(86) PCT No.: PCT/US15/63348

§ 371 Date: Jun. 1, 2017

Related U.S. Application Data
(60) Provisional application No. 62/088,913, filed on Dec. 8, 2014.

(51) Int. Cl. F21V 8/00; G02F 1/1335

(52) U.S. Cl. CPC G02B 6/0053; G02F 1/133514; G02B 6/0036; G02B 6/0055

(57) ABSTRACT

A transparent display includes a backlight unit (BLU) that includes a light guide plate (LGP). The BLU is configured to allow light to be transmitted from one surface of the LGP to the other wherein, in at least one selected area, the light transmitted across the LGP is not substantially interfered with from the display image such that both a background behind the display and a display image are viewable to an observer.

This application claims the benefit of priority under 35 U.S.C. §119 of U.S. Provisional Application Ser. No. 62/088,913 filed on Dec. 8, 2014 the content of which is relied upon and incorporated herein by reference in its entirety.

### BACKGROUND

### Field

The present disclosure relates generally to a transparent display and in particular to a transparent liquid crystal display (LCD) with improved contrast and transmission.

### Technical Background

Transparent displays, wherein a displayed imaged can be seen over a background, are generating increased commercial interest for a variety of applications, including vending machine doors, freezer doors, retail advertising, augmented reality screens, heads-up displays in the automotive industry, smart windows for offices, portable consumer electronics, and security monitoring.

Typically, transparent LCD displays include edge lit backlight units with relatively shallow light extraction features so that the light guide plate (LGP) looks mostly transparent with relatively low haze. The diffusive structure may be positioned behind a transparent display system, and light is introduced into a glass substrate of the backlight along one or more edges thereof, and/or along one or more borders thereof. The light propagates in a waveguide fashion within the glass substrate, e.g. by total internal reflection, and is incident on the light scattering portion. Thus, the light is scattered out of the transparent backlight to illuminate the LCD panel of the translucent display.

Transparent displays are, however, susceptible to several challenging performance characteristics. For example, such displays can be expected to present challenges relating to image noise, wherein an image, formed by a series of red-green-blue (RGB) windows or pixels are switched “on” and “off” to create an image and are illuminated by random extraction features. The brightness of individual sub-pixels depend on how many extraction features are being seen through the individual pixels. The randomness of these extraction features tends to create some image noise, commonly referred to as “sparkle.”

Such displays can additionally be expected to present challenges relating to image haziness and visibility, depending on the brightness of the image being displayed. For example, when displaying bright (or essentially white) images, the while light of the image is added to background light, which tends to create a hazy effect. In contrast, when displaying dark (or essentially black) images, most of the pixels are effectively switched “off”, such that the display is no longer transmissive, meaning that the background is no longer visible through the panel.

An additional issue is transparency or limited light transmission. For high resolution LCD displays, and when taking into account light absorbed by the polarizer and color filters, light transmission of the LCD panel may only be in the order of 7.5% such that, when the LCD display is intended to be transparent, background images may be relatively dim.

### SUMMARY

Disclosed herein is a display device that includes a backlight unit that includes a light guide plate. The light guide plate has a first major surface on a first side of the light guide plate, a second major surface on an opposite side of the light guide plate, and at least one edge having a surface that is substantially perpendicular to the first major surface. The backlight unit is configured to selectively transmit light from the edge to at least one first area of the second major surface. The backlight unit is also configured to transmit light from the first major surface to at least one second area of the second major surface. In addition, the backlight unit is configured to prevent light transmitted from the edge to substantially interfere with light transmitted from the first major surface to the at least one second area of the second major surface.

Additional features and advantages of these and other embodiments will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments of the present disclosure, and are intended to provide an overview or framework for understanding the nature and character of the embodiments as claimed. The accompanying drawings are included to provide a further understanding of these and other embodiments, and are incorporated into and constitute a part of this specification. The drawings illustrate various embodiments of these and other embodiments, and together with the description serve to explain the principles and operations thereof.

### BRIEF DESCRIPTION OF THE DRAWINGS

FIG. 1 is a schematic representation of an array of pixels wherein a first group of pixels have been configured as display pixels and a second group of pixels have been configured as background pixels;

FIG. 2 is a schematic representation of the array of pixels illustrated in FIG. 1 wherein color filters have been removed for the background pixels;

FIG. 3 is a schematic representation of an array of red-green-blue-white (RBGW) pixels arranged in a two-dimensional pattern, wherein a backlight unit (BLU) has extraction features aligned with the RGB pixels;

FIG. 4 is side cutaway view illustrating light emission phenomena associated with the arrangement illustrated in FIG. 3;

FIG. 5 is a schematic representation of an array of pixels illustrated in FIG. 2 wherein light extraction features are aligned with display pixels;

FIG. 6 is a side cutaway view illustrating an exemplary bonding configuration between an LGP and TFT substrate;

FIG. 7 is a schematic representation of light propagation, scattering, and extraction in an exemplary LGP;

FIG. 8 is a schematic representation of light propagation, scattering, and extraction in the LGP of FIG. 7 wherein a tuning medium (e.g., turning film) is positioned between the LGP and the TFT substrate;

FIG. 9 is a schematic representation of transmission of light associated with a display image and light associated with a background image, wherein the tuning medium is configured such that, in selected areas, light associated with the display image does not substantially interfere with light associated with the background image; and

FIG. 10 shows an exemplary “window” configuration, wherein a window shows a display image and the rest of the viewing area shows a background.

### DETAILED DESCRIPTION

Reference will now be made to embodiments of the present disclosure, examples of which are illustrated in the accompanying drawings. Whenever possible, the same reference numerals will be used throughout the drawings to refer to the same or like parts.

Transparent display systems, such as transparent and semi-transparent LCD televisions, can be designed for commercial applications such as digital signage and advertising. These display systems are semi-transparent in the “off” state (i.e., when no image is being commanded by the associated electronics driving the LCD elements). To maintain the semi-transparent characteristics, these display systems do not employ an opaque optical backplane to produce light. Instead, the display systems use background ambient light to illuminate the LCDs in the “on” state (i.e., when the associated electronics is commanding an image). Thus, one can see through the display and view objects (such as merchandise, etc.) behind the display panel. Concurrently, the viewer can also receive visual information on certain portions of the display panel (or the entire display panel), which in a commercial application would, for example, be related to the merchandise behind the screen.

Embodiments disclosed herein are related to transparent display devices and systems and, in particular, a display device that includes a backlight unit (BLU) that includes a light guide plate (LGP). The light guide plate has a first major surface on a first side of the light guide plate, a second major surface on an opposite side of the light guide plate, and at least one edge having a surface that is substantially perpendicular to the first major surface. The backlight unit is configured to selectively transmit light from the edge to at least one first area of the second major surface (i.e., image transmission). The backlight unit is also configured to transmit light from the first major surface to at least one second area of the second major surface (i.e., background transmission). In addition, the backlight unit is configured to prevent light transmitted from the edge to the at least one first area of the second major surface to substantially interfere with light transmitted from the first major surface to the at least one second area of the second major surface (by “substantially interfere” it is meant that light transmitted from the first major surface to the at least one second area of the second major surface is interfered with such that the background is not clearly visible through the device to an observer). This enables the display device to exhibit improved transparency and clarity, wherein a background is viewable through the display device to an observer facing the display device and, at the same time, displaying an image that is being commanded by the associated electronics driving the LCD elements. This improved transparency and clarity can be exhibited even when the image being displayed is either extremely bright (or white) or extremely dark (or black).

In addition to a light guide plate (LGP), display devices disclosed herein may also include a thin film transistor (TFT) substrate and a color filter (CF) substrate.

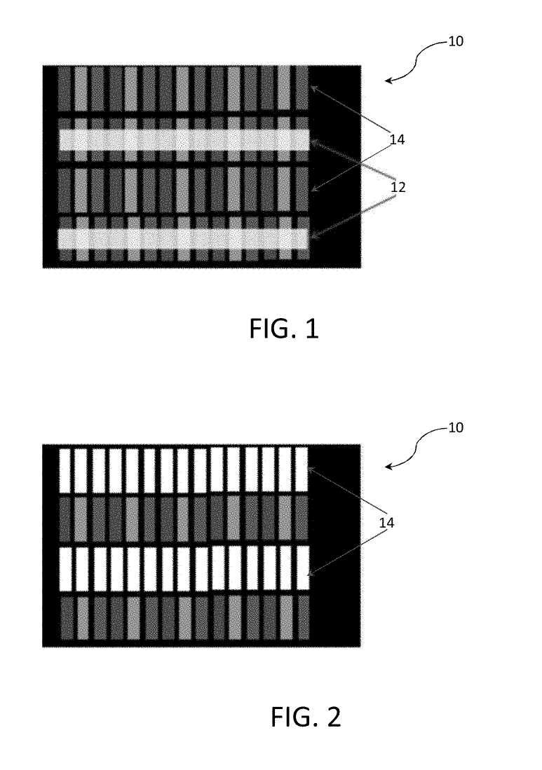

FIG. 1 shows a schematic representation of an array of pixels 10 wherein a first group of pixels 12 have been configured as display pixels and a second group of pixels 14 have been configured as background pixels. The areas of the first group of pixels 12 align with least one first area of the second major surface of the LGP (i.e., a “display” area) wherein the backlight unit is configured to selectively transmit light (i.e., “display” light) from the edge to at least one first area of the second major surface. The areas of at least the second group of pixels 14 align with at least one second area of the second major surface of the LGP (i.e., a “background” area) wherein the backlight unit is configured to transmit light (i.e., “background” light) from the first major surface to at least one second area of the second major surface. The backlight unit is configured to prevent light transmitted from the edge (i.e., “display” light) to substantially interfere with light (i.e., “background” light) transmitted from the first major surface to the at least one second area of the second major surface (i.e., the “background” area) that align with the second group of pixels 14. Alternatively stated, second group of pixels 14 (“background” pixels) correspond to light associated with a background being viewed through the device whereas the first group of pixels 12 (“display” pixels) correspond to light associated with an image being displayed by the device.

As can be seen from FIG. 1, embodiments herein include those in which the second major surface of the LGP includes a plurality of first and second areas.

As shown in FIG. 1, first group of pixels 12 and second group of pixels 14 are shown as alternating substantially parallel lines of pixels in array 10. While only two lines corresponding to the first and second groups of pixels are shown in FIG. 1, it should be appreciated that embodiments herein include those that include a plurality of substantially parallel lines greater than two corresponding to each of the first and second groups of pixels. Likewise, embodiments herein include those in which at least one first area (i.e., “display area”) extends along a length of the second major surface of the LGP and is substantially parallel and adjacent to at least one second area (i.e., “background area”) that extends along a length of the second major surface of the LGP.

In an alternative embodiment, shown in FIG. 10, a “window” configuration 100 can be provided wherein pixels associated with a background are effectively turned “off” and pixels associated with an image to be displayed are effectively turned “on” in a specified (i.e., window-shaped) area or window 102. In the remainder of the viewing area 104, the background is visible through the device. In the event the display includes a “touch” function, the position and size of the image window can be modified by a user. The display may also be switched between different modes.

FIG. 2 is a schematic representation of the array of pixels illustrated in FIG. 1 wherein color filters have been removed for the second group of pixels 14 (‘background pixels”). Since background pixels do not substantially contribute to the generation of the displayed image, color filters can be selectively removed so as to improve the overall transmission of background light through the panel.

While not limited to any particular material, conventional light guide plates are often made using polymers such as polymethyl methacrylate (PMMA) or polycarbonate. However, PMMA is very sensitive to moisture and, in addition, the coefficient of thermal expansion (CTE) of the LGP should preferably be as close as possible to the CTEs of the materials used for the TFT and CF substrates. Since TFT and CF substrates most typically comprise glass materials, the LGP preferably includes a glass substrate, most preferably a glass substrate having high light transmittance.

In addition, in order to facilitate the emission of the displayed image, at least a portion of the surface of the LGP closest to the TFT substrate (i.e., the “second major surface”) may include a plurality of surface features referred to as “extraction features.” When creating extraction features, one or more surfaces of the LGP may, for example, be roughened and a pattern of discrete dots of material may be patterned thereon. Exemplary glass LGP substrates and methods for creating extraction features thereon are disclosed in U.S. application Ser. No. 61/918,276, the entire disclosure of which is incorporated herein by reference.

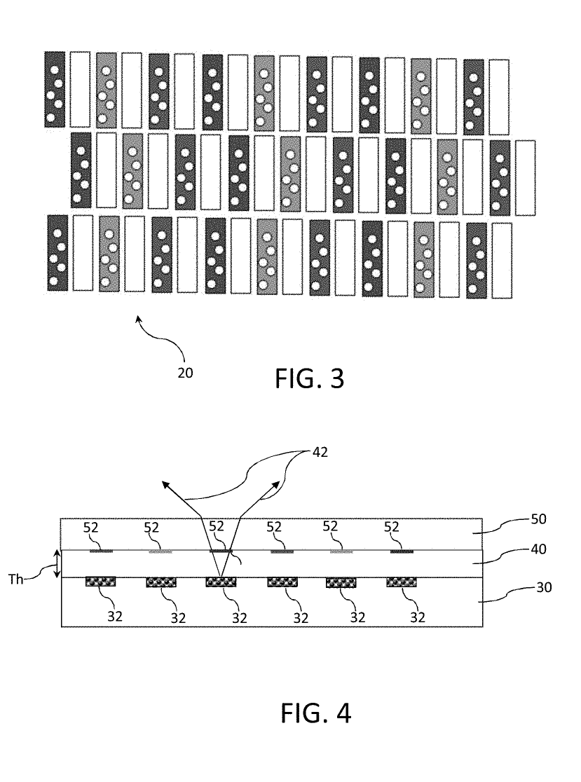

FIG. 3 is a schematic representation of an array 20 of red-green-blue-white (RBGW) pixels arranged in a two-dimensional pattern, wherein a backlight unit (BLU) has extraction features (shown in FIG. 3 as dots) aligned with the RGB pixels. FIG. 4 is side cutaway view illustrating light emission phenomena associated with the arrangement illustrated in FIG. 3, wherein TFT substrate 40 is sandwiched between LGP 30 and CF substrate 50, wherein LGP 30 includes light extraction features 32 that are aligned with pixels 52 and display light angle of emission is illustrated by arrows 42. Assuming that the light extraction features 32 are nearly in contact with the TFT substrate 40, the half angle of emission in glass can be calculated by:

Tan θ=Sub_pix/2/Th

Sin θ′=1.5 sin θ

Where Sub_pix is the size of the RGB sub pixels and Th is the thickness of the TFT substrate and θ and θ′ are the half angles of emission in glass and in air.

If an exemplary display size of 700×400mm with an image resolution of 1080p (1920×1080) is considered, pixel pitch is about 0.365 mm and sub pixel dimension is about a sixth of the pitch i.e. 0.061 mm. Assuming a TFT thickness (Th) of 0.55 mm, half angle of emission is about 4.7 degrees in air, which is quite limited. Consequently, when an observer is outside that substantially narrow angle of vision, only the background pixels will be illuminated, which is the opposite of the intended effect.

Accordingly, in order to improve the angle of vision, the alternating linear configuration shown in, e.g., FIG. 2 is preferred. In that case, the dimension of the sub-pixel to consider is half the pixel pitch which increases the angle of vision to +/−14 degrees. This angle can also be further increased by using lower resolution (larger panels) or by using a thinner TFT substrate. Moreover, in display and particularly public display applications, the angle of vision in the horizontal plane is more important than the angle of vision in the vertical plane. Accordingly, in a preferred embodiment, the RGB pixels and corresponding first and second areas of the second surface of the LGP extend in the horizontal direction when viewed by an observer.

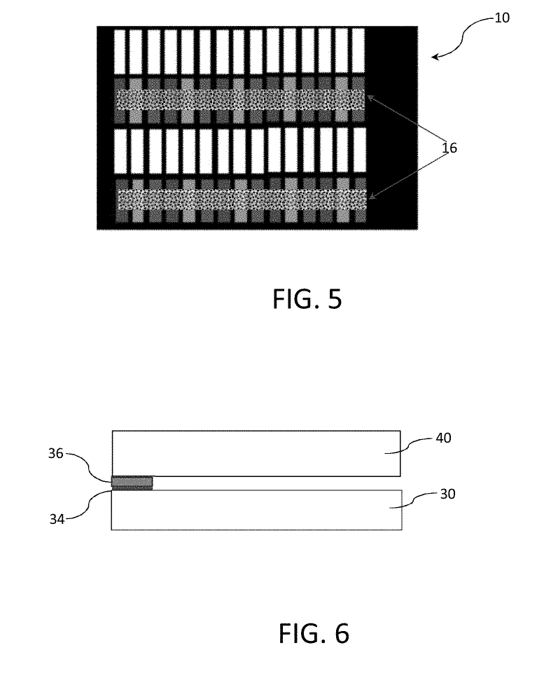

FIG. 5 is a schematic representation of an array of pixels 10 illustrated in FIG. 2 wherein light extraction features 16 are aligned with display pixels. Such extraction features can, for example, be patterned as lines, as shown in FIG. 5, or they can comprise a series of discontinued patterns set along lines. Light extraction rates may be adjusted by, for example, adjusting the width of the lines and/or adjusting the density of the extraction features inside the lines.

In addition, in order to maintain satisfactory alignment, the LGP will preferably be secured to the back of the TFT substrate. A difficulty arises, however, where bonding causes light to leak from the LGP into the TFT substrate. As shown in FIG. 6, an exemplary solution can include coating the edges of the LGP 30 with a reflective coating 34 so to cover the bonding area 36 with the TFT substrate 40. Preferably, the width of that bonding are should be as thin as possible, such as less than 2 millimeters, in order to minimize absorption effect into the reflective coating.

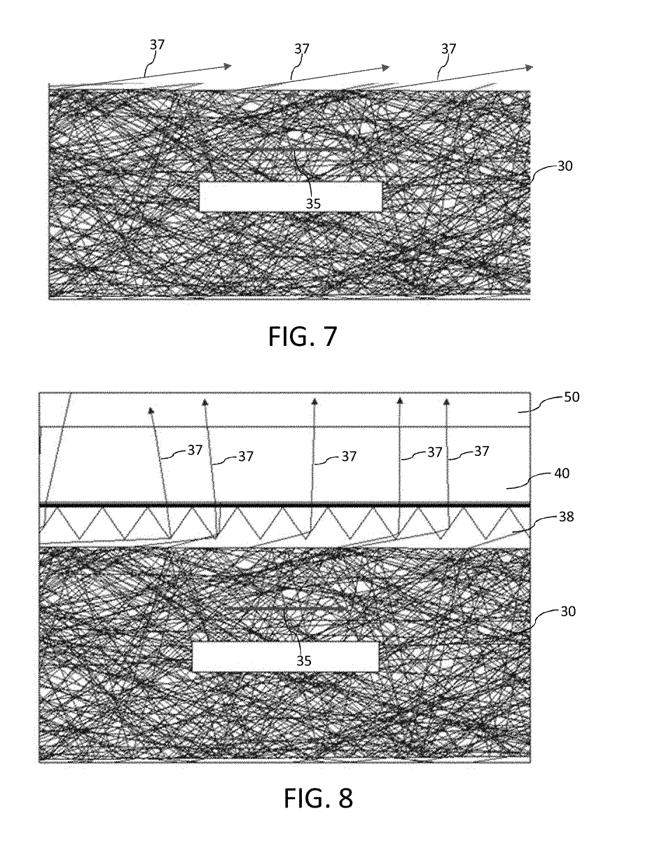

FIG. 7 is a schematic representation of light propagation, scattering, and extraction in an exemplary LGP 30. In a light guide, the light injected from the edge 35 propagates via total internal reflection. In case there is some roughness at the interface between the light guide and the air, part of the light will be scattered at each bouncing. A consequence of that scattering is that the angle of propagation of some of the rays will change. Accordingly, a ray propagating at an angle TIR-Δ (TIR meaning Total internal reflection angle) will now propagate at an angle TIR-Δ+ε where ε is the change in angle due to scattering event. In the case where ε is larger than Δ, the ray will be extracted from the waveguide since the angle now exceeds the TIR angle. However, in the case where the roughness is shallow enough and contains relatively low spatial frequencies (like 20 microns and larger), the new angle TIR-Δ+ε remains close to the TIR angle which means that the light will get extracted at a very high angle (grazing incidence). So, in such a system, most of the light gets extracted at an angle close to 90 degrees (as shown by arrows 37).

In order to use this mechanism for light guide extraction, an additional problem needs to be considered, namely as light gets extracted along the propagation direction, the density of power decreases resulting in decreasing the amount of light that can be extracted. This difficulty can be overcome by changing the scattering efficiency along the propagation direction. This can be achieved, for example, by increasing the depth of the roughness, by decreasing the thickness of the waveguide, or by increasing the spatial frequency of the roughness. The principle of the optimization consists in varying the roughness shape to obtain a homogeneous light leakage along the propagation direction.

In order to re-direct light at normal incidence, the device may further include a turning medium configured to turn light transmitted from the edge to the first area of the second major surface (i.e., “display” light). Turning media, such as turning films, typically include a linear array of prisms where, after a total internal reflection over a prism facet, light is re-directed toward the viewer. FIG. 8 is a schematic representation of light propagation, scattering, and extraction in the LGP of FIG. 7 wherein a turning medium 38 (e.g., turning film) is positioned between the LGP 30 and the TFT substrate 40. As can be seen in FIG. 8, turning medium re-directs extracted light, as shown by arrows 37.

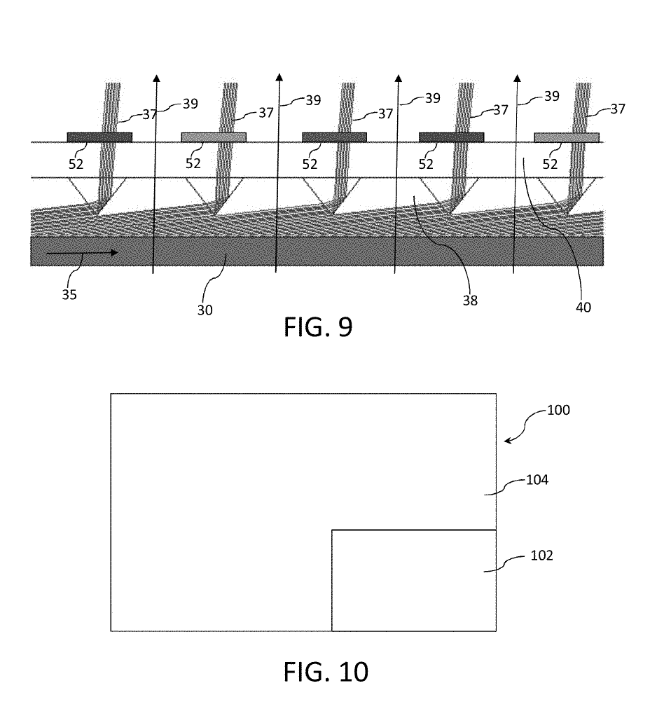

FIG. 9 is a schematic representation of transmission of light associated with a display image and light associated with a background image, wherein the turning medium 38 is configured such that, in selected areas, light associated with the display image does not substantially interfere with light associated with the background image. In the embodiment shown in FIG. 9, instead of creating an homogeneous illumination, the turning medium (turning film) creates a series of lines due to the fact that only a portion of the prisms are being illuminated when light comes at high incidence angle. For example, in the case of a leaky waveguide with only one propagating color, the back of the TFT substrate 40 can be laminated with the turning medium 38, wherein a series of lines for given colors 37 are aligned with the pixels 52 of those specific colors. By using prisms with the same period as the period of the pixels, an array of lines can be generated and, by having a duty factor of less than 50%, the display still exhibits transparency, as shown by the light propagation indicated by arrows 39. In the simulation that forms the basis for FIG. 9, the two angles at the base of the prisms were set to 52 degrees and the emission angle out of the LGP 30 was 80 degrees. Of course, other angles can be used and the direction of light emission can be modified by changing the angles of the prisms. This embodiment was validated by an experiment in which spatial energy was measured when injecting light into one side of a LGP having some shallow texture on it and covered with a Vikuiti turning film, manufactured by 3M Corporation. Lines were clearly observed, as predicted by the model.

It will be apparent to those skilled in the art that various modifications and variations can be made to the embodiments of the present disclosure without departing from the spirit and scope of the disclosure. Thus, it is intended that the present disclosure cover the modifications and variations of these and other embodiments provided they come within the scope of the appended claims and their equivalents.

What is claimed is:

1. A display device comprising:
a backlight unit comprising a light guide plate, the light guide plate having a first major surface on a first side of the light guide plate, a second major surface on an opposite side of the light guide plate, and at least one edge having a surface that is substantially perpendicular to the first major surface;
wherein the backlight unit is configured to selectively transmit light from the edge to at least one first area of the second major surface; and
wherein the backlight unit is configured to transmit light from the first major surface to at least one second area of the second major surface; and
wherein the backlight unit is configured to prevent light transmitted from the edge to substantially interfere with light transmitted from the first major surface to the at least one second area of the second major surface.

2. The display device according to claim 1, wherein the second major surface comprises a plurality of first and second areas.

3. The display device according to claim 1, wherein at least one first area extends along a length of the second major surface and is substantially parallel and adjacent to at least one second area that extends along a length of the second major surface.

4. The display device according to claim 3, wherein a plurality of first areas extend along a length of the second major surface and are each substantially parallel to at least one adjacent second area that extends along a length of the second major surface.

5. The display device according to claim 3, wherein the first and second areas extend in a horizontal direction when viewed by an observer.

6. The display device according to claim 1, wherein at least a portion of the first area of the second major surface comprises extraction features.

7. The display device according to claim 1, wherein the device further comprises a turning medium configured to turn light transmitted from the edge to the first area of the second major surface.

8. The display device according to claim 1, wherein the device further comprises a thin film transistor substrate.

9. The display device according to claim 1, wherein the device further comprises a color filter substrate.

10. The display device according to claim 1, wherein the light guide plate comprises a glass substrate.

11. The display device according to claim 1, wherein the device is configured to prevent at least a portion of light transmitted from the first major surface to the second area of the second major surface from passing through a color filter.

12. The display device according to claim 1, wherein a reflective material is deposited on at least the outer edges of the light guide plate.
